(19) United States
(12) Patent Application Publication
(10) Pub. No.: US 2012/0034838 A1
(43) Pub. Date: Feb. 9, 2012

(54) Polymeric Blends for Fiber Applications and Methods of Making the Same

(75) Inventors: Fengkui Li, Houston, TX (US); Tim Coffy, Houston, TX (US); Michel Daumerie, Houston, TX (US); John Bieser, Houston, TX (US); Ryan Albores, Pearland, TX (US)

(73) Assignee: Fina Technology, Inc., Houston, TX (US)

(21) Appl. No.: 12/851,554

(22) Filed: Aug. 6, 2010

(51) Int. Cl. D04H 13/00; C08L 67/00; C08L 63/00

(52) U.S. Cl. 442/401; 525/208; 525/190; 442/327

(57) ABSTRACT

Processes of forming a fiber article and articles formed therefrom are described herein. The processes generally include providing a propylene-based polymer; contacting the propylene-based polymer with polylactic acid in the presence of a reactive modifier, a non-reactive modifier or a combination thereof to form a polymeric blend, wherein the reactive modifier is selected from epoxy-functionalized polyolefins and the non-reactive modifier comprises an elastomer; and forming the polymeric blend into a fiber article.

### FIELD

Embodiments of the present invention generally relate to polymeric materials containing biodegradable components. In particular, the polymeric materials may be formed into continuous filaments, staple fibers, melt blown fabric, spunbond fabric and the like.

### BACKGROUND

Propylene polymer filaments, fibers, and nonwoven fabrics are widely used in the manufacture of many articles including twine, carpet fibers, carpet backing, medical gowns and drapes, diapers, filters, envelopes, and packaging, for example. The term “nonwoven fabric” generally refers to engineered or synthetic fabrics made from filaments or fibers placed together in the form of a sheet or web and bonded together by chemical, mechanical, or thermal treatment, such as melt blowing or spunbonding processes, for example.

Continuous filaments, staple fibers, melt blown nonwoven fabrics, spunbond nonwoven fabrics, and the like (referred to collectively herein as “fiber articles”) are routinely made of propylene-based polymers due to its low cost, easy processability and superior physical properties. However, it is well known that the printing and/or dyeing of nonpolar polyolefins (e.g., polypropylene) by common printing or dyeing techniques (e.g., dispersed dyeing techniques) is difficult due to its intrinsically low surface energy. With a surface energy typically in a range from about 30 to about 35 dynes/cm, polypropylene can exhibit weak hydrophilic properties. As a result, the most common method of preparing colored polypropylene fiber articles is to include solid pigment in the polypropylene composition before melt spinning. Alternatively, after spinning, polypropylene fibers and fabrics may be surface treated (e.g., via various plasma treatments) to increase its surface energy for improved printability and dye uptake.

Accordingly, it is desirable to provide propylene-based fiber articles with an increased number of dye receptors to improve its dyeability, such that additional surface treatment processing is unnecessary.

Furthermore, while fiber articles constructed from polypropylene and other synthetic polymeric materials have widespread utility, one environmental drawback to their use is that these materials tend to degrade slowly, if at all, in a natural environment. In response to environmental concerns, interest in the production and utility of more readily biodegradable polymeric materials has been increasing. These biodegradable materials, also known as “green materials”, may undergo accelerated degradation in a natural environment. However, the utility of these biodegradable polymeric materials is often limited by their poor mechanical and/or physical properties. Thus, a need exists for at least partially biodegradable polymeric compositions that may be processed into fiber articles having desirable physical and/or mechanical properties for the manufacture of biodegradable articles, thereby providing an environmentally friendly alternative to synthetic polymeric articles of manufacture.

### SUMMARY

Embodiments of the present invention include a process of forming a fiber article including providing a propylene-based polymer; contacting the propylene-based polymer with polylactic acid in the presence of a reactive modifier, a non-reactive modifier or a combination thereof to form a polymeric blend containing biodegradable components, wherein the reactive modifier is selected from epoxy-functionalized polyolefins and the non-reactive modifier includes an elastomer; and forming the polymeric blend into a fiber article.

In one or more embodiments, the process further includes orienting the filament.

One or more embodiments include the process of any preceding paragraph, wherein the propylene-based polymer is selected from polypropylene homopolymer, polypropylene based random copolymer, and polypropylene impact copolymer.

One or more embodiments include the process of any preceding paragraph, wherein the propylene-based polymer includes isotactic polypropylene.

One or more embodiments include the process of any preceding paragraph, wherein the propylene-based polymer has a melt flow rate in a range from about 10 dg/min to about 300 dg/min.

One or more embodiments include the process of any preceding paragraph, wherein the contact includes melt blending the propylene-based polymer, the polylactic acid, and the reactive modifier or non-reactive modifier or combinations thereof.

One or more embodiments include the process of any preceding paragraph, wherein the polylactic acid has a concentration in a range from about 1 wt. % to about 30 wt. % based on the weight of the polymeric blend.

One or more embodiments include the process of any preceding paragraph, wherein the reactive modifier has a concentration in a range from about 0.5 wt. % to about 5 wt. % based on the weight of the polymeric blend.

One or more embodiments include the process of any preceding paragraph, wherein the reactive modifier is glycidyl methacrylate grafted polypropylene.

One or more embodiments include the process of any preceding paragraph, wherein the reactive modifier is ethylene-glycidyl methacrylate copolymer.

One or more embodiments include the process of any preceding paragraph, wherein the reactive modifier is epoxidized polybutadiene.

One or more embodiments include the process of any preceding paragraph, wherein the non-reactive modifier is selected from styrene-ethylene/butylene-styrene tri-block copolymers (SEBS), ethylene methyl acrylate copolymers (EMA), ethylene-vinyl acetate copolymers (EVA) and combinations thereof.

One or more embodiments include a process of forming a fiber article including providing a propylene-based polymer having a melt flow rate in a range from about 10 dg/min to about 300 dg/min; contacting the propylene-based polymer with polylactic acid in the presence of a reactive modifier, a non-reactive modifier or combinations thereof to form a polymeric blend containing biodegradable components, wherein the reactive modifier is selected from epoxy-functionalized polyolefins; forming the polymeric blend into a filament; and orienting the filament.

One or more embodiments include a fiber article including one or more filaments or fibers, wherein each of the one or more filaments or fibers is formed by a process described in any preceding paragraph.

One or more embodiments include the fiber article of the preceding paragraph, wherein the article is a continuous filament.

One or more embodiments include the fiber article of any preceding paragraph, wherein the article is a staple fiber.

One or more embodiments include the fiber article of any preceding paragraph, wherein the article is a nonwoven fabric.

One or more embodiments include the fiber article of any preceding paragraph, wherein the nonwoven fabric is formed by melt spinning or spunbonding.

One or more embodiments include the fiber article of any preceding paragraph, wherein the article has a surface energy greater than about 38 dynes/cm.

One or more embodiments include the fiber article of any preceding paragraph, wherein the article is dyed by a disperse dying technique.

### BRIEF DESCRIPTION OF DRAWINGS

FIG. 1 is a schematic illustration of a Fourne fiber-spinning machine and drawing line.

FIG. 2 is a SEM micrograph of fully oriented yarn.

### DETAILED DESCRIPTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition skilled persons in the pertinent art have given that term as reflected in printed publications and issued patents at the time of filing. Further, unless otherwise specified, all compounds described herein may be substituted or unsubstituted and the listing of compounds includes derivatives thereof.

Further, various ranges and/or numerical limitations may be expressly stated below. It should be recognized that unless stated otherwise, it is intended that endpoints are to be interchangeable. Further, any ranges include iterative ranges of like magnitude falling within the expressly stated ranges or limitations.

Polymeric compositions containing biodegradable components and methods of making and using the same are described herein. The polymeric compositions are formed of an olefin based polymer, polylactic acid and a reactive modifier or a non-reactive modifier or a combination thereof.

As used herein, the term “biodegradable” refers to a material capable of at least partial breakdown. For example, the material may be broken down by the action of living things.

Embodiments described herein generally provide polymeric compositions containing biodegradable components that may be processed into fibers and/or filaments having desirable mechanical and physical properties (e.g., increased surface energy) for the manufacture of articles that are “green” and dyeable via disperse dyeing techniques.

### Catalyst Systems

Catalyst systems useful for polymerizing olefin monomers include any suitable catalyst system. For example, the catalyst system may include chromium based catalyst systems, single site transition metal catalyst systems including metallocene catalyst systems, Ziegler-Natta catalyst systems or combinations thereof, for example. The catalysts may be activated for subsequent polymerization and may or may not be associated with a support material, for example. A brief discussion of such catalyst systems is included below, but is in no way intended to limit the scope of the invention to such catalysts.

For example, Ziegler-Natta catalyst systems are generally formed from the combination of a metal component (e.g., a catalyst) with one or more additional components, such as a catalyst support, a cocatalyst and/or one or more electron donors, for example.

Metallocene catalysts may be characterized generally as coordination compounds incorporating one or more cyclopentadienyl (Cp) groups (which may be substituted or unsubstituted, each substitution being the same or different) coordinated with a transition metal through it bonding. The substituent groups on Cp may be linear, branched or cyclic hydrocarbyl radicals, for example. The cyclic hydrocarbyl radicals may further form other contiguous ring structures, including indenyl, azulenyl and fluorenyl groups, for example. These contiguous ring structures may also be substituted or unsubstituted by hydrocarbyl radicals, such as C₁ to C₂₀ hydrocarbyl radicals, for example.

### Polymerization Processes

As indicated elsewhere herein, the catalyst systems are used to form olefin based polymer compositions (which may be interchangeably referred to herein as polyolefin polymers or polyolefins). Once the catalyst system is prepared, as described above and/or as known to one skilled in the art, a variety of processes may be carried out using that composition to form olefin based polymers. The equipment, process conditions, reactants, additives and other materials used in polymerization processes will vary in a given process, depending on the desired composition and properties of the polymer being formed. Such processes may include solution phase, gas phase, slurry phase, bulk phase, high pressure processes or combinations thereof, for example. (See, U.S. Pat. No. 5,525,678; U.S. Pat. No. 6,420,580; U.S. Pat. No. 6,380,328; U.S. Pat. No. 6,359,072; U.S. Pat. No. 6,346,586; U.S. Pat. No. 6,340,730; U.S. Pat. No. 6,339,134; U.S. Pat. No. 6,300,436; U.S. Pat. No. 6,274,684; U.S. Pat. No. 6,271,323; U.S. Pat. No. 6,248,845; U.S. Pat. No. 6,245,868; U.S. Pat. No. 6,245,705; U.S. Pat. No. 6,242,545; U.S. Pat. No. 6,211,105; U.S. Pat. No. 6,207,606; U.S. Pat. No. 6,180,735 and U.S. Pat. No. 6,147,173, which are incorporated by reference herein.)

In certain embodiments, the processes described above generally include polymerizing one or more olefin monomers to form the polyolefin polymers. The olefin monomers may include C₂ to C₃₀ olefin monomers, or C₂ to C₁₂ olefin monomers (e.g., ethylene, propylene, butene, pentene, 4-methyl-1-pentene, hexene, octene and decene), for example. It is further contemplated that the monomers may include olefinic unsaturated monomers, C₄ to C₁₈ diolefins, conjugated or nonconjugated dienes, polyenes, vinyl monomers and cyclic olefins, for example. Non-limiting examples of other monomers may include norbornene, norbornadiene, isobutylene, isoprene, vinylbenzycyclobutane, styrene, alkyl substituted styrene, ethylidene norbornene, dicyclopentadiene and cyclopentene, for example. The formed polymer may include homopolymers, copolymers or terpolymers, for example.

Examples of solution processes are described in U.S. Pat. No. 4,271,060, U.S. Pat. No. 5,001,205, U.S. Pat. No. 5,236,998 and U.S. Pat. No. 5,589,555, which are incorporated by reference herein.

One example of a gas phase polymerization process includes a continuous cycle system, wherein a cycling gas stream (otherwise known as a recycle stream or fluidizing medium) is heated in a reactor by heat of polymerization. The heat may be removed from the cycling gas stream in another part of the cycle by a cooling system external to the reactor. The cycling gas stream containing one or more monomers may be continuously cycled through a fluidized bed in the presence of a catalyst under reactive conditions. The cycling gas stream is generally withdrawn from the fluidized bed and recycled back into the reactor. Simultaneously, polymer product may be withdrawn from the reactor and fresh monomer may be added to replace the polymerized monomer. The reactor pressure in a gas phase process may vary from about 100 psig to about 500 psig, or from about 200 psig to about 400 psig or from about 250 psig to about 350 psig, for example. The reactor temperature in a gas phase process may vary from about 30° C. to about 120° C., or from about 60° C. to about 115° C., or from about 70° C. to about 110° C. or from about 70° C. to about 95° C., for example. (See, for example, U.S. Pat. No. 4,543,399; U.S. Pat. No. 4,588,790; U.S. Pat. No. 5,028,670; U.S. Pat. No. 5,317,036; U.S. Pat. No. 5,352,749; U.S. Pat. No. 5,405,922; U.S. Pat. No. 5,436,304; U.S. Pat. No. 5,456,471; U.S. Pat. No. 5,462,999; U.S. Pat. No. 5,616,661; U.S. Pat. No. 5,627,242; U.S. Pat. No. 5,665,818; U.S. Pat. No. 5,677,375 and U.S. Pat. No. 5,668,228, which are incorporated by reference herein.)

Slurry phase processes generally include forming a suspension of solid, particulate polymer in a liquid polymerization medium, to which monomers and optionally hydrogen, along with catalyst, are added. The suspension (which may include diluents) may be intermittently or continuously removed from the reactor where the volatile components can be separated from the polymer and recycled, optionally after a distillation, to the reactor. The liquefied diluent employed in the polymerization medium may include a C₃ to C₇ alkane (e.g., hexane or isobutane), for example. The medium employed is generally liquid under the conditions of polymerization and relatively inert. A bulk phase process is similar to that of a slurry process with the exception that the liquid medium is also the reactant (e.g., monomer) in a bulk phase process. However, a process may be a bulk process, a slurry process or a bulk slurry process, for example.

In a specific embodiment, a slurry process or a bulk process may be carried out continuously in one or more loop reactors. The catalyst, as slurry or as a dry free flowing powder, may be injected regularly to the reactor loop, which can itself be filled with circulating slurry of growing polymer particles in a diluent, for example. Optionally, hydrogen (or other chain terminating agents, for example) may be added to the process, such as for molecular weight control of the resultant polymer. The loop reactor may be maintained at a pressure of from about 27 bar to about 50 bar or from about 35 bar to about 45 bar and a temperature of from about 38° C. to about 121° C., for example. Reaction heat may be removed through the loop wall via any suitable method, such as via a double jacketed pipe or heat exchanger, for example.

Alternatively, other types of polymerization processes may be used, such as stirred reactors in series, parallel or combinations thereof, for example. Upon removal from the reactor, the olefin based polymer may be passed to a polymer recovery system for further processing, such as addition of additives and/or extrusion, for example.

### Polymer Product

The polymeric composition containing biodegradable components includes one or more polyolefins. The polyolefins (and blends thereof) formed via the processes described herein may include, but are not limited to, linear low density polyethylene, elastomers, plastomers, high density polyethylenes, low density polyethylenes, medium density polyethylenes, polypropylene and polypropylene copolymers, for example.

Unless otherwise designated herein, all testing methods are the current methods at the time of filing.

In one or more embodiments, the polyolefins include propylene based polymers. As used herein, the term “propylene based” is used interchangeably with the terms “propylene polymer” or “polypropylene” and refers to a polymer having at least about 50 wt. %, or at least about 70 wt. %, or at least about 75 wt. %, or at least about 80 wt. %, or at least about 85 wt. % or at least about 90 wt. % polypropylene relative to the total weight of polyolefin, for example.

In one or more embodiments, the propylene based polymers may have a molecular weight distribution (Mₙ/M_{w}) of from about 1.0 to about 20, or from about 1.5 to about 15 or from about 2 to about 12, for example.

In one or more embodiments, the propylene based polymers may have a melting point (Tₘ) (as measured by differential scanning calorimetry) of at least about 135° C., or from about 135° C. to about 170° C., or from about 150° C. to about 170° C., for example.

In one or more embodiments, the propylene based polymers may have a melt flow rate (MFR) (as determined in accordance with ASTM D-1238 condition “L”) of from about 8 dg/min. to about 500 dg/min., or from about 10 dg/min. to about 400 dg/min., or from about 12 dg/min. to about 300 dg/min.

In one embodiment, propylene based polymers may have a molecular weight (M_{w}) (as measured by gel permeation chromatography) of from about 80,000 to about 400,000, or from about 120,000 to about 300,000 or from about 160,000 to about 220,000, for example.

In one or more embodiments, the polyolefins include polypropylene homopolymers. Unless otherwise specified, the term “polypropylene homopolymer” refers to propylene homopolymers, i.e., polypropylene, or those polyolefins composed primarily of propylene and amounts of other comonomers, wherein the amount of comonomer is insufficient to change the crystalline nature of the propylene polymer significantly.

In one or more embodiments, the polyolefins include polypropylene based random copolymers. Unless otherwise specified, the term “propylene based random copolymer” refers to those copolymers composed primarily of propylene and an amount of at least one comonomer, wherein the polymer includes at least about 0.5 wt. %, or at least about 0.8 wt. %, or at least about 2 wt. %, or from about 0.5 wt. % to about 5.0 wt. %, or from about 0.6 wt. % to about 1.0 wt. % comonomer relative to the total weight of polymer, for example. The comonomers may be selected from _{C2} to _{C10} alkenes. For example, the comonomers may be selected from ethylene, propylene, 1-butene, 1-pentene, 1-hexene, 1-heptene, 1-octene, 1-nonene, 1-decene, 4-methyl-1-pentene and combinations thereof. In one specific embodiment, the comonomer includes ethylene. Further, the term “random copolymer” refers to a copolymer formed of macromolecules in which the probability of finding a given monomeric unit at any given site in the chain is independent of the nature of the adjacent units.

In one or more embodiments, the polyolefins include polypropylene impact copolymers. Unless otherwise specified, the term “polypropylene impact copolymer” refers to a semi-crystalline polypropylene or polypropylene copolymer matrix containing a heterophasic copolymer. The heterophasic copolymer includes ethylene and higher alpha-olefin polymer such as amorphous ethylene-propylene copolymer, for example.

The polymeric composition containing biodegradable components may include at least 40 wt. %, or from about 41 wt. % to about 98.5 wt. %, or from about 52 wt. % to about 96 wt. %, or from about 65 wt. % to about 93 wt. % polyolefin based on the total weight of the polymeric composition, for example.

One or more of the polyolefins are contacted with a polyester, such as polylactic acid (PLA), to form the polymeric composition containing biodegradable components (which may also be referred to herein as a blend or blended material). Such contact may occur by a variety of methods. For example, such contact may include blending of the olefin based polymer and the polylactic acid under conditions suitable for the formation of a blended material. Such blending may include dry blending, extrusion, mixing or combinations thereof, for example.

In one or more embodiments, the polymeric composition containing biodegradable components further includes polylactic acid. The polylactic acid may include any polylactic acid capable of blending with an olefin based polymer. For example, the polylactic acid may be selected from poly-L-lactide (PLLA), poly-D-lactide (PDLA), poly-LD-lactide (PDLLA) and combinations thereof. The polylactic acid may be formed by known methods, such as dehydration condensation of lactic acid (see, U.S. Pat. No. 5,310,865, which is incorporated by reference herein) or synthesis of a cyclic lactide from lactic acid followed by ring opening polymerization of the cyclic lactide (see, U.S. Pat. No. 2,758,987, which is incorporated by reference herein), for example. Such processes may utilize catalysts for polylactic acid formation, such as tin compounds (e.g., tin octylate), titanium compounds (e.g., tetraisopropyl titanate), zirconium compounds (e.g., zirconium isopropoxide), antimony compounds (e.g., antimony trioxide) or combinations thereof, for example.

In one or more embodiments, the polylactic acid may have a density of from about 1.238 glee to about 1.265 glee, or from about 1.24 glee to about 1.26 g/cc or from about 1.245 glee to about 1.255 glee (as determined in accordance with ASTM D792).

In one or more embodiments, the polylactic acid may exhibit a melt index (210° C., 2.16 kg) of from about 5 g/10 min. to about 1000 dg/min., or from about 10 dg/min. to about 500 dg/min. or from about 10 dg/min. to about 100 dg/min. (as determined in accordance with ASTM D1238).

In one or more embodiments, the polylactic acid may exhibit a crystalline melt temperature (Tₘ) of from about 150° C. to about 180° C., or from about 160° C. to about 175° C. or from about 160° C. to about 170° C. (as determined in accordance with ASTM D3418).

In one or more embodiments, the polylactic acid may exhibit a glass transition temperature of from about 45° C. to about 85° C., or from about 50° C. to about 80° C. or from about 55° C. to about 75° C. (as determined in accordance with ASTM D3417).

In one or more embodiments, the polylactic acid may exhibit a tensile yield strength of from about 4,000 psi to about 25,000 psi, or from about 5,000 psi to about 20,000 psi or from about 5,500 psi to about 20,000 psi (as determined in accordance with ASTM D638).

In one or more embodiments, the polylactic acid may exhibit a tensile elongation of from about 1.5% to about 10%, or from about 2% to about 8% or from about 3% to about 7% (as determined in accordance with ASTM D638).

In one or more embodiments, the polylactic acid may exhibit a flexural modulus of from about 250,000 psi to about 600,000 psi, or from about 300,000 psi to about 550,000 psi or from about 400,000 psi to about 500,000 psi (as determined in accordance with ASTM D790).

In one or more embodiments, the polylactic acid may exhibit a notched Izod impact of from about 0.1 ft-lb/in to about 1.5 ft-lb/in, or from about 0.2 ft-lb/in to about 1.0 ft-lb/in or from about 0.4 ft-lb/in to 0.6 about ft-lb/in (as determined in accordance with ASTM D256).

The polymeric composition containing biodegradable components may include from about 1 wt. % to about 49 wt. %, or from about 3 wt. % to about 40 wt. %, or from about 5 wt. % to about 30 wt. % polylactic acid based on the total weight of the polymeric composition, for example.

In one aspect, the use of PLA in the polymeric composition provides the composition with a certain degree of biodegradability. In another aspect, the PLA imparts enhanced dyeablity to the polymeric composition or articles, such as filaments, fibers, nonwoven fabrics and the like made therefrom. Incorporating PLA into the composition provides an increased number of polar groups (e.g., dye receptors) on the surface of articles made therefrom. As a result, increasing the polarity of the surface or surface energy increases polar interactions between dye molecules and the surface, thereby imparting enhanced printability as well as enhanced dyeability by common disperse dyeing techniques. Increasing the intrinsic surface energy of fiber articles made from the polymeric composition advantageously eliminates the potential need for conventional surface treatment processing of such articles in order to increase its surface energy for improving printability or dye uptake.

In one or more embodiments, the polymeric composition containing biodegradable components may further include a reactive modifier. As used herein, the term “reactive modifier” refers to polymeric additives that, when directly added to a molten blend of immiscible polymers (e.g., the polyolefin and the PLA), may chemically react with one or both of the blend components to increase adhesion and stabilize the blend. The reactive modifier may be incorporated into the polymeric composition via a variety of methods. For example, during melt blending, the polyolefin and the polylactic acid may be contacted with one another in the presence of the reactive modifier.

The reactive modifier may include functional polymers capable of compatibilizing a blend of polyolefin and polylactic acid (PO/PLA blend). Suitable reactive modifiers include epoxy-functionalized polyolefins, for example.

In one or more embodiments, the functional polymer is a graftable polyolefin selected from polypropylene, polyethylene, homopolymers thereof, copolymers thereof, and combinations thereof.

In one or more embodiments, the epoxy-functionalized polyolefins suitable for use in this disclosure include, without limitation, epoxy-functionalized polypropylene such as glycidyl methacrylate grafted polypropylene (PP-g-GMA), epoxy-functionalized polyethylene such as ethylene-glycidyl methacrylate copolymer (PE-co-GMA), epoxy-functionalized polybutadiene such as epoxidized hydroxyl-terminated polybutadiene (e.g., Polybd-605 and Polybd 600, commercially available from Cray Valley Corp.), and combinations thereof. An example of an epoxy-functionalized polyethylene suitable for use in this disclosure includes LOTADER® GMA products (e.g., LOTADER® AX8840, which is a random copolymer of ethylene and glycidyl methacrylate (PE-co-GMA) containing 8% GMA, or LOTADER® AX8900 which is a random terpolymer of ethylene, methyl acrylate and glycidyl methacrylate containing 8% GMA) that are commercially available from Arkema Corp.

The reactive modifiers may be prepared by any suitable method. For example, the epoxy-functionalized polypropylene reactive modifier may be formed by a grafting reaction. The grafting reaction may occur in a molten state inside of an extruder, for example (e.g., “reactive extrusion”). Such grafting reaction may occur by feeding the feedstock sequentially along the extruder or the feedstock may be pre-mixed and then fed into the extruder, for example.

In one or more embodiments, the reactive modifiers are formed by grafting in the presence of an initiator, such as peroxide. Examples of initiators may include LUPERSOL® 101 and TRIGANOX® 301, commercially available from Arkema, Corp., for example.

The initiator may be used in an amount of from about 0.01 wt. % to about 2 wt. % or from about 0.2 wt. % to about 0.8 wt. % or from about 0.3 wt. % to about 0.5 wt. % based on the total weight of the reactive modifier, for example.

In one embodiment, the grafting reaction of GMA onto PP may be conducted in a molten state inside an extruder, such as a single extruder or a twin-screw extruder. Hereinafter, such process is referred to as reactive extrusion. A feedstock comprising PP, GMA, and initiator (e.g., peroxide) may be fed into an extruder reactor sequentially along the extruder, alternatively the feedstock (e.g., PP, GMA, and initiator) may be pre-mixed outside and fed into the extruder.

In an alternative embodiment, the PP-g-GMA is prepared by grafting GMA onto polypropylene in the presence of an initiator and a multi-functional acrylate comonomer. The multi-functional acrylate comonomer may comprise polyethylene glycol diacrylate, trimethylolpropane triacrylate (TMPTA), or combinations thereof.

The multi-functional acrylate comonomer may be further characterized by a high flash point The flash point of a material is the lowest temperature at which it can form an ignitable mixture in air, as determined in accordance with ASTM D93. The higher the flash point, the less flammable the material, which is a beneficial attribute for melt reactive extrusion. In an embodiment, the multi-functional acrylate comonomer may have a flash point of from about 50° C. to about 120° C., or from about 70° C. to about 100° C., or from about 80° C. to 100° C. Examples of multi-functional acrylate comonomers suitable for use in this disclosure include without limitation SR259 (polyethylene glycol diacrylate), CD560 (alkoxylated hexanediol diacrylate), and SR351 (TMPTA), which are commercially available from Cray Valley Corp.

In one or more embodiments, the reactive modifier may include from about 80 wt. % to about 99.5 wt. %, or from about 90 wt. % to about 99 wt. % or from about 95 wt. % to about 99 wt. % polyolefin based on the total weight of the reactive modifier, for example.

In one or more embodiments, the reactive modifier may include from about 0.5 wt. % to about 20 wt. %, or from about 1 wt. % to about 10 wt. % or from about 1 wt. % to about 5 wt. % grafting component (i.e., the epoxy functional group (e.g., GMA)) based on the total weight of the reactive modifier, for example.

In one or more embodiments, the reactive modifier may exhibit a grafting yield of from about 0.2 wt. % to about 20 wt. %, or from about 0.5 wt. % to about 10 wt. % or from about 1 wt. % to about 5 wt. %, for example. The grafting yield may be determined by Fourier Transform Infrared Spectroscopy (FTIR) spectroscopy.

The polymeric composition containing biodegradable components may include from about 0.5 wt. % to about 10 wt. %, or from about 1.0 wt. % to about 8 wt. % or from about 2 wt. % to about 5 wt. % reactive modifier based on the total weight of the polymeric composition, for example. (See, Table 1 below for a non-limiting example of the components of a polymeric composition.)

TABLE 1

| POLMERIC COMPOSITION | AMOUNT IN COMPOSITION |
|---|---|
| COMPONENT | (wt. %) |
| Polyolefin | from about 40 to about 99 |
| Polyester | from about 1 to about 49 |
| Reactive Modifier | from 0 to about 10 |

The polymeric composition containing biodegradable components may exhibit a melt flow rate of from about 0.5 g/10 min. to about 500 g/10 min., or from about 1.5 g/10 min. to about 50 g/10 min. or from about 5.0 g/10 min. to about 20 W10 min, for example. (MFR as defined herein refers to the quantity of a melted polymer resin that will flow through an orifice at a specified temperature and under a specified load. The MFR may be determined using a dead-weight piston Plastometer that extrudes polypropylene through an orifice of specified dimensions at a temperature of 230° C. and a load of 2.16 kg in accordance with ASTM D1238.)

In one or more embodiments, the polymeric composition containing biodegradable components may be prepared by contacting the polyolefin (PO), PLA or other polyester, and reactive modifier under conditions suitable for the formation of a polymeric blend. The blend may be compatibilized by reactive extrusion compounding of the PO, PLA, and reactive modifier. For example, polypropylene, PLA, and a reactive modifier (e.g., PE-co-GMA) may be dry blended, fed into an extruder, and melted inside the extruder. The mixing may be carried out using a continuous mixer such as a mixer having an intermeshing co-rotating twin screw extruder for mixing and melting the components and a single screw extruder or gear pump for pumping.

In an embodiment, the polymeric composition containing biodegradable components may also contain additives to impart desired physical properties. Examples of additives may include, without limitation, stabilizers, ultra-violet screening agents, oxidants, anti-oxidants, anti-static agents, ultraviolet light absorbents, fire retardants, processing oils, mold release agents, coloring agents, pigments/dyes, fillers or combinations thereof, for example. These additives may be included in amounts effective to impart the desired properties.

In one or more embodiments, the polymeric composition containing biodegradable components may further include a non-reactive modifier. As used herein, the term “non-reactive modifier” refers to polymeric additives that, when directly added to a molten blend of immiscible polymers (e.g., the polyolefin and the PLA), may interact with one or both of the blend components through associated forces to increase adhesion and stabilize the blend. The non-reactive modifier may be incorporated into the biodegradable polymeric composition via a variety of methods. For example, during melt blending the polyolefin and the polylactic acid may be contacted with one another in the presence of the non-reactive modifier.

In one or more embodiments, the non-reactive modifiers may include an optional hydrogenated midblock of styrene-ethylene/butylene-styrene tri-block copolymers (SEBS), ethylene methyl acrylate copolymers (EMA), ethylene-vinyl acetate copolymers (EVA), and combinations thereof, for example. Examples of SEBS include G1643 and FG1901 commercially available from Kraton Corp. Examples of EMA include SP1305, SP1307, SP2205, and SP2207 commercially available from Westlake Chemical Comp. Examples of EVA include Elvax series commercially available from DuPont Corp.

### Product Application

The polymeric composition containing biodegradable components have particular application to the formation of fiber articles, e.g., filaments, fibers and nonwoven fabrics formed therefrom. For example, fibers may be formed into nonwoven materials via melt blowing or spunbonding processing. Accordingly, the following description is with reference to the formation of fibers for example only and is not intended to limit the scope of the invention to such.

Fibers may be formed by any suitable melt spinning procedure, such as the Fourne melt spinning procedure, as will be understood by those skilled in the art. In using a Fourne fiber-spinning machine the polymeric composition, typically in the form of pellets, is passed from a suitable supply source and heated to a suitable temperature for extrusion within the range from about 180° C. to about 220° C. and then through a metering pump to a spin extruder. The fiber preforms thus formed are cooled in air then applied through one or more Godets to a spinning role which is operated at a desired spinning rate, typically about 500-1500 meters per minute. The thus-fainted filaments are drawn off the spin role to the drawing roller that is operated at a substantially enhanced speed in order to produce the drawn fiber. The draw speed may range from about 500 to about 4000 meters per minute and is operated relative to the spinning Godet to provide the desired draw, such as within the range of 1:1 to 6:1.

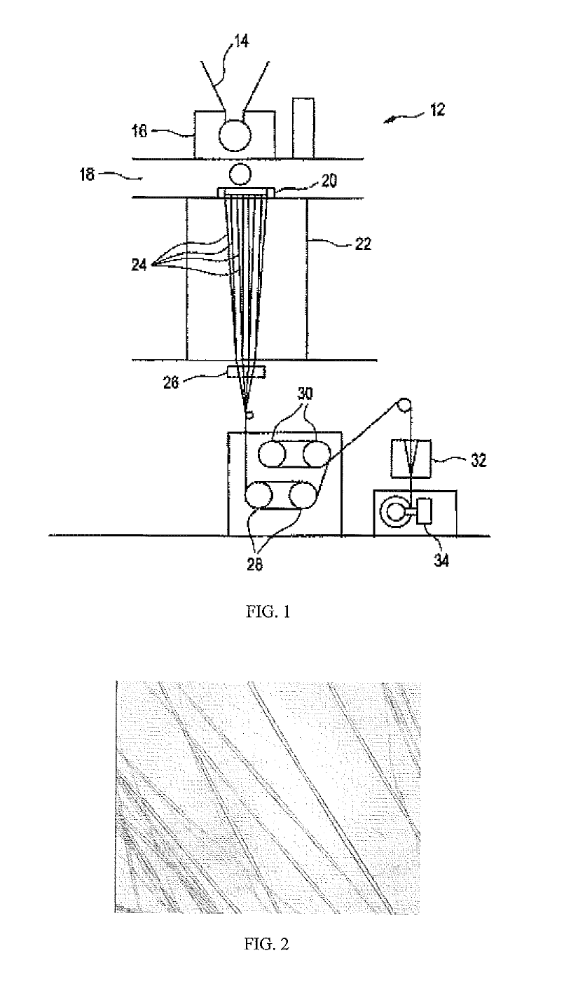

A Fourne fiber-spinning machine, which may be used to form fibers constructed from the compositions of the present invention, is illustrated in FIG. 1. The Fourne melt spinning procedure may include passing pellets of the biodegradable polymeric composition from a hopper 14 through a heat exchanger 16, where the pellets are heated to an extrusion temperature, and then through a metering pump 18 (also called a spin pump) to a spin extruder 20 (also called a spin pack), such that the melted polymer is forced through die-plate holes or holes of a spinneret. The portion of the machine from the hopper 14 through the spin pack 20 is collectively referred to an extruder 12. The polymer exiting the holes of the spin pack 20 form fiber preforms 24 that are cooled in air in a quench column 22 and then passed through a spin finisher 26. The collected fibers are then applied through one or more Godets to a take-away roll, illustrated in this embodiment as rolls 28 (also collectively referred to as Godet 1). These rolls are operated at a desired take-away rate (referred to as the G1 speed) such as at a rate of from about 500 to about 1500 meters per minute, for example. The thus-formed filaments are drawn off the spin role to the drawing rollers 30 (also collectively referred to as Godet 2) that are operated at a substantially enhanced speed (the draw speed or G2 speed) in order to produce the drawn fiber. The draw speed may range from about 500 to about 4,000 meters per minute and is operated relative to the take-away Godet 1 to provide the desired draw ratio, such as within the range from about 1:1 to about 6:1.

In one embodiment, the spun and drawn fiber is passed through a texturizer 32 and then wound up on a winder 34. While the illustrated embodiment and description encompasses the spinning and drawing of a fully oriented yarn, the same equipment may also be used to make a partially oriented yarn. In this case the drawing step is omitted, leaving only the act of spinning the yarn out of the extruder. This step is often accomplished by connecting winder 34 immediately following spin finisher 26 and involves bypassing drawing rollers 30. The force of winding/spinning the yarn off of the extruder does result in some stress and elongation, partially orienting the yarn, but does not provide the full benefits of a complete drawing process.

In one or more embodiments, non-woven fabric may be produced using known spunbonding techniques. For example, spunbonded fibers or spunbonded nonwoven fabrics may be formed by extruding a molten polymeric composition as filaments via a plurality of fine, usually circular capillaries of a spinneret. The filaments may be aspirated and deposited randomly onto a moving perforated belt, forming a web. The web may be bonded by heat or chemically by the use of adhesives, for example, to form a non-woven scrim fabric. The spunbonded fibers may have a diameter greater than about 2 microns, or in a range from about 10 microns to about 25 microns, for example.

In one or more embodiments, non-woven fabric may be produced using known melt blowing techniques. For example, meltblown fibers and meltblown fabrics may be formed by extruding a molten composition of the present invention through a plurality of fine, usually circular capillaries as molten filaments into converging high velocity gas streams which attenuate the filaments to reduce their diameter. Thereafter the meltblown fibers are carried by the high velocity gas stream and are deposited onto a collecting surface to form a web of randomly dispersed meltblown fibers. Generally, meltblown fibers are microfibers that are either continuous or discontinuous and may be smaller than 10 microns, or less than 5 microns, or in a range from about 1 micron to about 3 microns in diameter, for example. In addition, the meltblown fibers may be weakly bonded from intertangling of the small diameter fibers as well as from the temporary tackiness of the fibers when deposited onto a collecting surface to form the fabric.

In one or more embodiments, the fibers may also be used to prepare thermally bonded non-woven fabrics such as those used for medical gowns and drapes, diapers and other catamenial devices, filters, and the like. These fabrics can be formed by carding thermally bonded staple fiber produced from polymeric compositions of the present invention and thermally bonding such web in a heated calendar roll.

In one or more embodiments, the fiber articles are formed from polymeric compositions of the present invention, wherein the polypropylene component of the blend has a melt flow rate in a range from about 10 dg/min. to about 300 dg/min.

In one or more embodiments, the fiber articles are formed from polymeric compositions of the present invention, wherein the polypropylene component of the blend is isotactic polypropylene.

In one or more embodiments, the fiber articles are formed from polymeric compositions of the present invention, wherein the polypropylene component is isotactic polypropylene produced by supported Ziegler-Natta catalyst. For example, Ziegler-Natta catalysts may include zirconium or titanium tetrachloride supported on crystalline supports such as magnesium dichloride. An alternative procedure has been to use isotactic polypropylene produced by isospecific metallocene catalysts.

In one or more embodiments, the fiber and nonwoven fabric articles produced from the polymeric compositions disclosed herein may unexpectedly display an improved dyeability when compared to an otherwise similar article lacking a PLA component. The polar nature of PLA may provide the fibers and nonwoven articles with an increased surface energy to enhance the compatibility with common printing or dyeing techniques (e.g., disperse dyeing techniques) that utilize dyes and/or coloring agents which are also typically polar. For example, disperse dyeing techniques may include dispersing dye particles in water and subsequently immersing the fiber or fabric article in the dispersion to permit polar interactions between the dye particles and the polymeric structure of the article. Suitable examples of disperse dyes used for coloring fibers or nonwoven fabrics include monoazodye and anthraquinone dye, for example. The increased surface energy imparts increased wettability and increased polar forces to absorb a coloring agent or dye more readily than an otherwise similar article lacking a PLA component.

In one or more embodiments, the fiber and nonwoven fabric articles produced from the polymeric compositions disclosed herein may display an improved printability when compared to an otherwise similar article lacking a PLA component. Without wishing to be limited by theory, the polar nature of PLA may afford improved printability and/or an improved surface treatment for printing.

### EXAMPLES

The following examples are for illustration purposes only, and are not intended to be limiting.

Four samples were prepared to evaluate the suitability of blends comprising polylactic acid with and without reactive modifier for fiber processing. For comparison purposes, the first sample was an isotactic metallocene-catalyzed polypropylene homopolymer having a 14 dg/min melt flow rate, commercially available as Total Petrochemicals M3661 (“neat M3661”), referred to herein as the reference sample. The second sample was a blend of neat M3661 PP and PLA 6201D, referred to herein as PP/PLA blend, wherein the concentration of PLA was about 10 wt. % based on the total weight of the blend. The second sample blend was prepared by compounding the PP and PLA components in a 27 mm twin-screw extruder. The third and fourth samples were blends prepared by melt blending the reactive modifier additives glycidyl methacrylate grafted polypropylene (PP-g-GMA) and polyethylene-glycidyl methacrylate random copolymer (PE-co-GMA), respectively, with neat M3661 PP and 10 wt. % PLA 6201D, wherein the concentration of the reactive modifier in each of these samples was about 3 wt % based on the total weight of the blend. The third and fourth sample blends were also prepared by compounding the PP, PLA and reactive modifier (PP-g-GMA or PE-co-GMA) components in a 27 mm twin-screw extruder. In summary, the first sample was PP (the reference sample), the second sample was a blend of PP/10 wt. % PLA, the third sample was a blend of PP/3 wt. % PP-g-GMA/10 wt. % PLA, and the fourth sample was a blend of PP/3 wt. % PE-co-GMA/10 wt. % PLA.

To evaluate the suitability and effectiveness of each of the sample formulations for fiber processing, formed polymer pellets of each sample were processed at an extrusion temperature in a range from about 215° C. to about 220° C. through a Fourne fiber line to produce fibers of each sample. The extrusion or melt temperature was kept within the range of 215° C. to 220° C. to minimize thermal degradation of the PLA component in samples 2, 3 and 4.

Fiber processing of sample 1 successfully produced fibers of neat M3661 PP. No processing issues were encountered during processing at take-up speeds of up to about 4000 m/min and at a throughput of about 1.0 g/min./hole.

In contrast, fiber processing of sample 2 was problematic due to sporadic filament breaks of free falling extruded strands. As a result, it was difficult to make any oriented fibers from the PP/PLA blend of sample 2.

Fiber processing of sample 3 was also somewhat problematic due to occasional filament breaks of free falling extruded strands. Thus, it was somewhat difficult to make oriented fibers from the PP/PP-g-GMA/PLA blend of sample 3.

However, rather unexpectedly, fiber processing of sample 4 successfully produced fibers without any filament breaks of free falling extruded strands. Fibers of PP/PE-co-GMA/PLA were formed at a maximum take up speed about 1000 m/min. Because it was difficult to aspirate the strands, the strands were manually guided to produce fully oriented fibers. It should be noted that a small increase in the melt temperature improved fiber aspiration. FIG. 2 shows a micrograph of yarns produced from sample 4 at a 1.5:1 draw ratio. Upon inspection of the micrograph, it is noted that the fiber diameter or thickness appears somewhat nonuniform. To enhance fiber diameter uniformity and/or facilitate fiber spinning, higher melt flow rate polypropylene may be preferably utilized in the blends of the present invention. Most notably, the blend of sample 4 comprising the reactive modifier PE-co-GMA to compatibilize the PP/PLA blend may be successfully processed to form fibers.

While the foregoing is directed to embodiments of the present invention, other and further embodiments of the invention may be devised without departing from the basic scope thereof and the scope thereof is determined by the claims that follow.

What is claimed is:

1. A process of forming a fiber article comprising:
providing a propylene-based polymer;
contacting the propylene-based polymer with polylactic acid in the presence of a reactive modifier, a non-reactive modifier or a combination thereof to form a polymeric blend, wherein the reactive modifier is selected from epoxy-functionalized polyolefins and the non-reactive modifier comprises an elastomer; and
forming the polymeric blend into a fiber article.

2. The process of claim 1, further comprising orienting the filament.

3. The process of claim 1, wherein the propylene-based polymer is selected from polypropylene homopolymer, polypropylene based random copolymer, and polypropylene impact copolymer.

4. The process of claim 1, wherein the propylene-based polymer comprises isotactic polypropylene.

5. The process of claim 1, wherein the propylene-based polymer has a melt flow rate in a range from about 10 dg/min to about 300 dg/min.

6. The process of claim 1, wherein the contact comprises melt blending the propylene-based polymer, the polylactic acid, and the reactive modifier or non-reactive modifier or combinations thereof.

7. The process of claim 1, wherein the polylactic acid has a concentration in a range from about 1 wt. % to about 30 wt. % based on the weight of the polymeric blend.

8. The process of claim 1, wherein the reactive modifier has a concentration in a range from about 0.5 wt. % to about 10 wt. % based on the weight of the polymeric blend.

9. The process of claim 1, wherein the reactive modifier is glycidyl methacrylate grafted polypropylene.

10. The process of claim 1, wherein the reactive modifier is ethylene-glycidyl methacrylate copolymer.

11. The process of claim 1, wherein the reactive modifier is epoxidized polybutadiene.

12. The process of claim 1, wherein the non-reactive modifier is selected from styrene-ethylene/butylene-styrene tri-block copolymers (SEGS), ethylene methyl acrylate copolymers (EMA), ethylene-vinyl acetate copolymers (EVA) and combinations thereof.

13. A process of forming a fiber article comprising:
providing a propylene-based polymer having a melt flow rate in a range from about 10 dg/min to about 300 dg/min;
contacting the propylene-based polymer with polylactic acid in the presence of a reactive modifier, a non-reactive modifier or combinations thereof to form a biodegradable polymeric blend, wherein the reactive modifier is selected from epoxy-functionalized polyolefins;
forming the polymeric blend into a filament; and
orienting the filament.

14. The process of claim 13, wherein the propylene-based polymer comprises isotactic polypropylene.

15. The process of claim 13, wherein the polylactic acid has a concentration in a range from about 1 wt. % to about 30 wt. % based on the weight of the biodegradable polymeric blend.

16. The process of claim 13, wherein the reactive modifier has a concentration in a range from about 0.5 wt. % to about 5 wt. % based on the weight of the polymeric blend.

17. The process of claim 16, wherein the reactive modifier is glycidyl methacrylate grafted polypropylene.

18. The process of claim 16, wherein the reactive modifier is ethylene-glycidyl methacrylate copolymer.

19. The process of claim 16, wherein the reactive modifier is epoxidized polybutadiene.

20. The process of claim 16, wherein the non-reactive modifier is selected from styrene-ethylene/butylene-styrene tri-block copolymers (SEBS), ethylene methyl acrylate copolymers (EMA), ethylene-vinyl acetate copolymers (EVA) and combinations thereof.

21. A fiber article comprising one or more filaments or fibers, wherein each of the one or more filaments or fibers is formed by a process comprising:
providing a propylene-based polymer;
contacting the propylene-based polymer with polylactic acid in the presence of a reactive modifier, a non-reactive modifier or combinations thereof to form a polymeric blend, wherein the reactive modifier is selected from epoxy-functionalized polyolefins;
forming the polymeric blend into a fiber or filament; and
forming the fiber or filament into a fiber article.

22. The article of claim 21, wherein the process further comprises orienting the fiber or filament.

23. The article of claim 21, wherein the propylene-based polymer has a melt flow rate in a range from about 10 dg/min to about 300 dg/min.

24. The article of claim 22, wherein the propylene-based polymer comprises isotactic polypropylene.

25. The article of claim 21, wherein the reactive modifier comprises glycidyl methacrylate grafted polypropylene.

26. The article of claim 21, wherein the reactive modifier comprises ethylene-glycidyl methacrylate copolymer.

27. The process of claim 21, wherein the reactive modifier is epoxidized polybutadiene.

28. The process of claim 21, wherein the non-reactive modifier is selected from styrene-ethylene/butylene-styrene tri-block copolymers (SEBS), ethylene methyl acrylate copolymers (EMA), ethylene-vinyl acetate copolymers (EVA) and combinations thereof.

29. The article of claim 21, wherein the polylactic acid has a concentration in a range from about 1 wt. % to about 30 wt. % based on the weight of the melt blended mixture.

30. The article of claim 21, wherein the reactive modifier has a concentration in a range from about 0.5 wt. % to about 5 wt. % based on the weight of the melt blended mixture.

31. The article of claim 21, wherein the article is a continuous filament.

32. The article of claim 21, wherein the article is a staple fiber.

33. The article of claim 21, wherein the article is a nonwoven fabric.

34. The article of claim 31, wherein the nonwoven fabric is formed by melt spinning or spunbonding.

35. The article of claim 21, wherein the article has a surface energy greater than about 38 dynes/cm.

36. The article of claim 21, wherein the article is dyed by a disperse dying technique.
